(19) United States
(12) Patent Application Publication
(10) Pub. No.: US 2024/0304047 A1
(43) Pub. Date: Sep. 12, 2024

(54) MANAGEMENT SYSTEM

(71) Applicant: TOYOTA JIDOSHA KABUSHIKI KAISHA, Toyota-shi (JP)

(72) Inventors: Hiroya CHIBA, Fuji-shi (JP); Tatsuya SUGANO, Sunto-gun (JP); Nobutsugu MARUIWA, Mishima-shi (JP); Tetsuro SUGIURA, Chofu-shi (JP); Daisuke KAKUMA, Susono-shi (JP)

(21) Appl. No.: 18/426,563

(22) Filed: Jan. 30, 2024

(30) Foreign Application Priority Data
Mar. 7, 2023 (JP) 2023-034945

(51) Int. Cl. G07C 5/10; G07C 5/00; G07C 5/08

(52) U.S. Cl. CPC G07C 5/10; G07C 5/008; G07C 5/0808

(57) ABSTRACT

The present disclosure relates to a management system for managing a vehicle having a remote activation function. The management system includes processing circuitry. The processing circuitry activates the vehicle and acquire remaining battery level of the vehicle at check timing while the vehicle is parked and performs a restoration promoting process for restoring the remaining battery level in a case where the remaining battery level is equal to or lower than a threshold value. The threshold value is set to a value larger than a remote activation lower limit that is a lower limit of the remaining battery level necessary for remote activation of the vehicle.

### CROSS-REFERENCE TO RELATED APPLICATION

The present application claims priority under 35 U.S.C. § 119 to Japanese Patent Application No. 2023-034945, filed on Mar. 7, 2023, the contents of which application are incorporated herein by reference in their entirety.

### BACKGROUND

### Field

The present disclosure relates to a management system which manages a vehicle.

### Background Art

Patent Literature 1 discloses an air conditioning device for a vehicle capable of performing pre-air conditioning operation for air-conditioning a vehicle cabin before an occupant gets in the vehicle. The air conditioning device includes an air conditioning ECU. The air-conditioning ECU acquires an amount of charge of a battery and acquires information about traveling of the vehicle scheduled to be performed next time. The air conditioning ECU performs the pre-air conditioning operation when a predicted amount of the charge of the battery at a start time of the next traveling exceeds a total amount of electric power obtained by adding a predicted amount of the electric power consumed by a motor for traveling and auxiliary machinery and the predicted amount of the electric power consumed by the pre-air conditioning operation.

Patent Literature 2 discloses a vehicle system applied to a vehicle using a solar cell. According to the vehicle system disclosed in Patent Literature 2, in a case where an in-vehicle device can be operated by electric power generated by the solar cell, the in-vehicle device is operated by using the electric power generated by the solar cell.

### LIST OF RELATED ART

Patent Literature 1: Japanese Laid-Open Patent Application No. 2017-159691
Patent Literature 2: Japanese Patent No. 6197383

### SUMMARY

A vehicle having a remote activation function is considered. While the vehicle is parked, remaining battery level of the vehicle decreases due to standby power consumption or the like. Then, when the remaining battery level becomes low, there is a possibility that a communication device changes into a sleep state and the vehicle becomes not be able to be remotely activated.

An object of the present disclosure is to provide a technique capable of maintaining a state in which a vehicle can be remotely activated regardless of a parking period of the vehicle.

The present disclosure relates to a management system for managing a vehicle having a remote activation function. The management system includes processing circuitry. The processing circuitry activates the vehicle and acquire remaining battery level of the vehicle at check timing while the vehicle is parked and performs a restoration promoting process for restoring the remaining battery level in a case where the remaining battery level is equal to or lower than a threshold value. The threshold value is set to a value larger than a remote activation lower limit that is a lower limit of the remaining battery level necessary for remote activation of the vehicle.

According to the present disclosure, the remaining battery level is checked while the vehicle is parked, and the restoration promoting process is performed in a case where the remaining battery level is equal to or lower than the threshold value. By the restoration promoting process, the remaining battery level is restored before the remaining battery level becomes lower than an amount necessary for the remote activation of the vehicle. Therefore, the vehicle can be kept being able to be remotely activated regardless of a parking period of the vehicle.

### BRIEF DESCRIPTION OF THE DRAWINGS

FIG. 1 is a schematic diagram for explaining an overview of a management system according to a present embodiment.

FIG. 2 is a diagram for explaining check of a remaining battery level by a management device according to the present embodiment.

FIG. 3 is a block diagram showing an example of the configuration of the management system according to the present embodiment.

FIG. 4 is a flowchart showing an example of processing by the management device according to the present embodiment.

FIG. 5 is a graph for explaining a first modification.

FIG. 6 is a graph for explaining a second modification.

### DETAILED DESCRIPTION

Embodiments of the present disclosure will be described with reference to the accompanying drawings.

### 1. Overview of Management System

The management system according to the present embodiment is a system including a vehicle having a remote activation function and a management device that manages the vehicle. The vehicle managed by the management system may be an automobile using an internal combustion engine as a power source, a hybrid automobile including both an internal combustion engine and a motor as power sources, or an electric automobile using a motor as a power source. Examples of the vehicle having the remote activation function include an automatic driving vehicle and an automated valet parking (AVP) vehicle capable of automatic driving in a predetermined area.

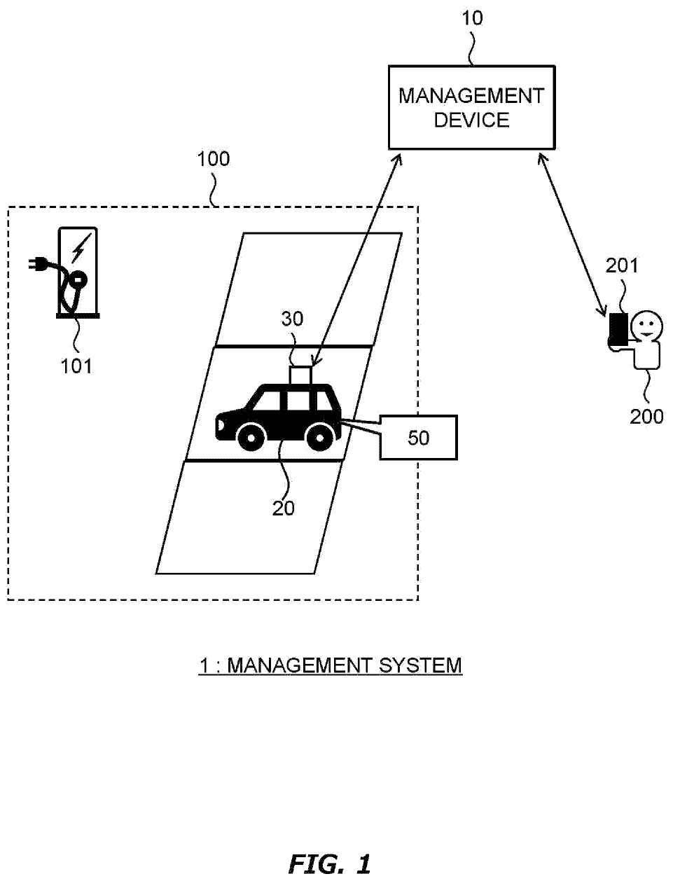

FIG. 1 is a schematic diagram for explaining management of a vehicle 20 by a management system 1 according to the present embodiment. In the example of FIG. 1, the vehicle 20 is an AVP vehicle, and can perform automatic driving at least in the parking place 100. The management system 1 includes a management device 10 and a vehicle 20. The management device 10 is typically a server that communicates with the vehicle 20. The vehicle 20 includes a communication device 30 for communicating with the management device 10.

The vehicle 20 is equipped with a battery 50. The electric power stored in the battery 50 is used to operate various in-vehicle devices including the communication device 30. In addition, when the vehicle 20 includes a motor, the electric power of the battery is also used to drive the motor. In addition, when the vehicle 20 includes an internal combustion engine, the electric power of the battery is used also when the internal combustion engine is ignited. The parking place 100 may be provided with a charging device 101, and in this case, the vehicle 20 may automatically travel to the charging device 101 to charge the battery 50.

The management device 10 may communicate with the communication device 30 of the vehicle 20 through a wireless network. The communication device 30 can receive an instruction from the management device 10 or transmit information to the management device 10 by communicating with the management device 10.

The management device 10 may further be capable of communicating with a user terminal 201 owned by a user 200 of the vehicle 20. The management device 10 communicates with the user terminal 201, thereby receiving a request for leaving the vehicle 20 from the user 200 and acquiring the scheduled leaving time of the vehicle 20.

While the vehicle 20 is parked in the parking place 100, the power supply of the vehicle 20 is in an OFF state. The communication device 30 is kept in the standby state. The standby state is a state in which at least a part of the functions is operating so as to be able to receive communication from the management device 10. In the standby state, the operation of the functions other than the function for receiving the communication from the management device 10 may be stopped. In this case, the communication device 30 is activated when receiving the communication from the management device 10, and the stopped function is operated again.

The management device 10 can remotely activate the vehicle 20 as necessary. More specifically, the management device 10 transmits an activation instruction to the vehicle 20. The communication device 30 of the vehicle 20 receives the activation instruction transmitted from the management device 10. In response to the reception of the activation instruction, the vehicle 20 is activated, that is, the power of the vehicle 20 is turned on. In this way, the remote activation function of the vehicle 20 is realized. When the vehicle 20 is activated, information acquired from various devices mounted on the vehicle 20 can be transmitted from the communication device 30 to the management device 10.

For example, when the management device 10 receives a request for leaving the vehicle 20 from the user 200 or when the scheduled leaving time of the vehicle 20 approaches, the management device 10 remotely activates the vehicle 20. In response to the activation instruction from the management device 10, the vehicle 20 is activated. Thereafter, in order to cause the vehicle 20 to exit the parking lot by the AVP, a function necessary for the traveling of the vehicle 20 is further started. For example, when the vehicle 20 uses a motor as a power source, the motor is started. Alternatively, when the vehicle 20 uses an internal combustion engine as a power source, the internal combustion engine is started. In this way, the vehicle 20 can automatically travel in the parking place 100 under the management of the management device 10 and move to an area for the user 200 to board the vehicle 20.

In order to start the vehicle 20 to a drivable state, electric power supplied from the battery 50 is required. While the vehicle 20 is parked, the remaining battery level (State of Charge: SOC) of the battery 50 gradually decreases due to standby power of various in-vehicle devices, natural discharge, and the like. Further, power is consumed to keep the communication device 30 in the standby state. Therefore, the remaining battery level is provided with a lower limit value for setting the communication device 30 in the standby state or the activated state. Hereinafter, this lower limit value is referred to as a “remote activation lower limit value”. When the remaining battery level becomes equal to or lower than the remote activation lower limit value, the communication device 30 transitions to the idle state in order to preserve the remaining battery level minimally required for starting the vehicle 20. The idle state is a state in which all functions of the communication device 30 are stopped, and the communication device 30 cannot accept communication from the management device 10 in the idle state. That is, the remote activation lower limit value can be rephrased as a lower limit value of the remaining battery level required for remotely activating the vehicle 20. When the remaining battery level decreases to the remote activation lower limit value or less, the management device 10 cannot remotely activate the vehicle 20.

If the vehicle 20 continues to be parked without any measures, the remaining battery level gradually decreases and eventually becomes equal to or lower than the remote activation lower limit value. Therefore, in particular, in a case where the parking period of the vehicle 20 is long, or the like, the remote activation cannot be performed when the user 200 desires to leave the vehicle 20, and a situation in which the AVP cannot be used may occur. This is inconvenient for the user 200 who intends to use the vehicle 20.

The management system 1 according to the present embodiment has been made in view of such a problem. In order to prevent the vehicle 20 from being remotely activated when the vehicle 20 leaves the parking lot due to the decrease in the remaining battery level, the management device 10 checks the remaining battery level in advance and restores the remaining battery level if necessary. The processing performed by the management device 10 will be described in more detail below.

### 2. Acquisition of Remaining Battery Level and Restoration Promoting Processing

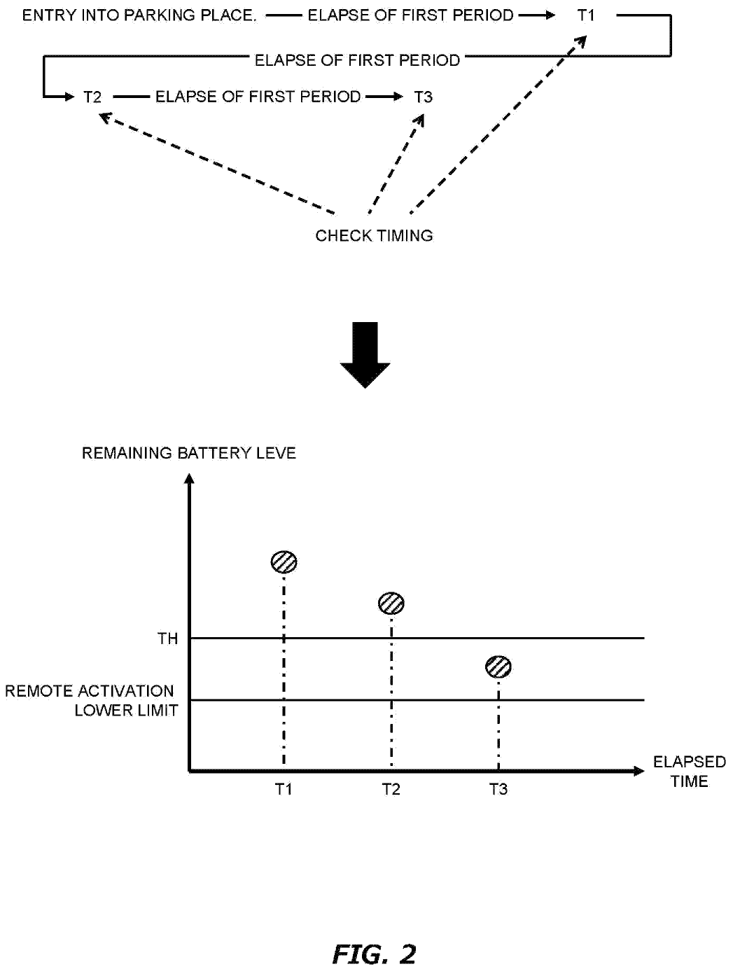

FIG. 2 is a diagram for explaining the checking of the remaining battery level by the management device 10. The management device 10 remotely activates the vehicle 20 at the “check timing” during parking of the vehicle 20, and acquires the remaining battery level of the vehicle 20.

The check timing is a timing at which a “first period” has elapsed since the vehicle 20 entered the parking place 100 or since the vehicle 20 was previously activated. In the example of FIG. 2, the timings T1, T2, and T3 are the check timings.

The first period is an arbitrary period set in advance. The first period may be a fixed period or a variable period. However, in any case, the first period is desirably set to a period with a margin so that the check timing comes before the remaining battery level falls below the remote activation lower limit value. For example, if the period from when the vehicle 20 enters the garage to when the remaining battery level becomes equal to or lower than the remote activation lower limit value is four days on average, it is assumed that the first period is set to a shorter period (for example, two days).

As an example of the variable period, the first period may be a period that varies according to the environment of the parking place. The rate of decrease in the remaining battery level may vary depending on the environment of the parking place. For example, if the parked vehicle 20 is exposed to direct sunlight or a low temperature environment, it is expected that the decreasing speed of the remaining battery level will be increased. Therefore, when the environment of the parking place is such an environment, the first period may be set to be short. Alternatively, the first period (in the example of FIG. 2, the period from the vehicle entry to the timing T1), which is the first period after the vehicle 20 enters the parking space, may be changed in accordance with the remaining battery level at the time of the vehicle entry of the vehicle 20. It is expected that the period from when the vehicle 20 enters the parking lot to when the remaining battery level becomes equal to or lower than the remote activation lower limit value becomes shorter as the remaining battery level at the time of entering the parking lot is smaller. Therefore, the first period may be set to be shorter as the remaining battery level at the time of entering is lower.

The management device 10 communicates with the communication device 30 to remotely activate the vehicle 20 and acquires the remaining battery level every time the check timing arrives. The graph at the bottom of FIG. 2 shows the remaining battery level that has been obtained. The management device 10 checks whether the obtained remaining battery level is equal to or less than the threshold value TH. Then, as a result of the check, when the remaining battery level is equal to or less than the threshold value TH, the management device 10 performs the “recovery promoting process” for recovering the remaining battery level.

The threshold value TH is set in advance to be a value that is at least larger than the remote activation lower limit value. The difference between the threshold TH and the remote activation lower limit value is hereinafter referred to as an offset. The offset may be a fixed value. Alternatively, the offset may be set as a value that can be varied according to the type of the vehicle 20 or the parking situation. For example, when the vehicle 20 is equipped with an internal combustion engine, the remaining battery level can be recovered by starting the internal combustion engine to generate power, and thus the offset may be set to be smaller than that in the case where the vehicle 20 is not equipped with an internal combustion engine. However, in any case, it is desirable that the threshold value TH is set to a value having a margin with respect to the remote activation lower limit value so that the recovery facilitating process is performed before the remaining battery level falls below the remote activation lower limit value.

The remaining battery level is consumed by the standby power of the communication device 30 and the like, and thus, as illustrated in the lower graph of FIG. 2, the remaining battery level gradually decreases in the order of the timings T1, T2, and T3. At the timing T3, the remaining battery level is lower than the reference value TH. Therefore, the management device 10 performs the recovery facilitating process at the timing T3.

The restoration promoting process is a process for recovering the remaining battery level. Examples of the recovery promoting process include the following. In a first example, the vehicle 20 is automatically driven to the charging device 101 and is charged. This is an example of a case where the vehicle 20 includes a motor as a power source. The travel of the vehicle 20 to the charging device 101 may be controlled by the management device 10 or may be controlled by a control device mounted on the vehicle 20. When the charging is completed, the vehicle 20 returns to the original position or an empty parking frame. Then, the vehicle 20 is turned off again, and the communication device 30 is in the standby state again.

In this case, the offset may be set to increase as the distance from the parking position of the vehicle 20 to the charging device 101 increases. Electric power is used to drive the motor even while the vehicle 20 travels to the charging device 101. Therefore, setting the offset in this way is effective in preventing the remaining battery level from falling below the remaining battery level required for traveling until the vehicle 20 arrives at the charging device 101.

The second example is to prompt the user 200 to use the vehicle 20. As a method of prompting the user 200 to use the vehicle 20, for example, when the vehicle 20 is a vehicle personally owned by the user 200, it is assumed that a notification recommending the use of the vehicle 20 is transmitted to the user terminal 201. Alternatively, for example, when the vehicle 20 is a vehicle 20 shared by a plurality of users 200, such as a rental car, it is assumed that an incentive such as a discount of a usage fee related to the vehicle 20 is given to the user 200 to encourage the user 200 to preferentially use the vehicle 20. When the vehicle 20 is used by the user 200, it is expected that the vehicle 20 is charged by the user 200 and the remaining battery level is recovered.

A third example is to notify the manager of the vehicle 20 of the remaining battery level. The notification of the remaining battery level can prompt the administrator to charge the vehicle 20. The administrator of the vehicle 20 may be the same person as the user 200 or may be a different person. For example, when the vehicle 20 is a rental car, the administrator of the vehicle 20 is assumed to be an administrator of the rental car and a person different from the user 200.

The fourth example is an example in which the vehicle 20 is a vehicle equipped with an internal combustion engine. In this case, the restoration promoting processing may be to operate the internal combustion engine. The remaining battery level can be recovered by charging the battery with the power generated by the activated internal combustion engine.

As described above, according to the management system 1 of the present embodiment, the remaining battery level can be recovered by the recovery facilitating process before the vehicle 20 cannot be remotely activated due to the shortage of the remaining battery level. In this way, the management device 10 keeps the vehicle 20 in a state of being remotely activated regardless of the period during which the vehicle 20 is stored in the parking place 100. Therefore, the convenience of the user 200 can be improved.

### 3. Configuration of Management System

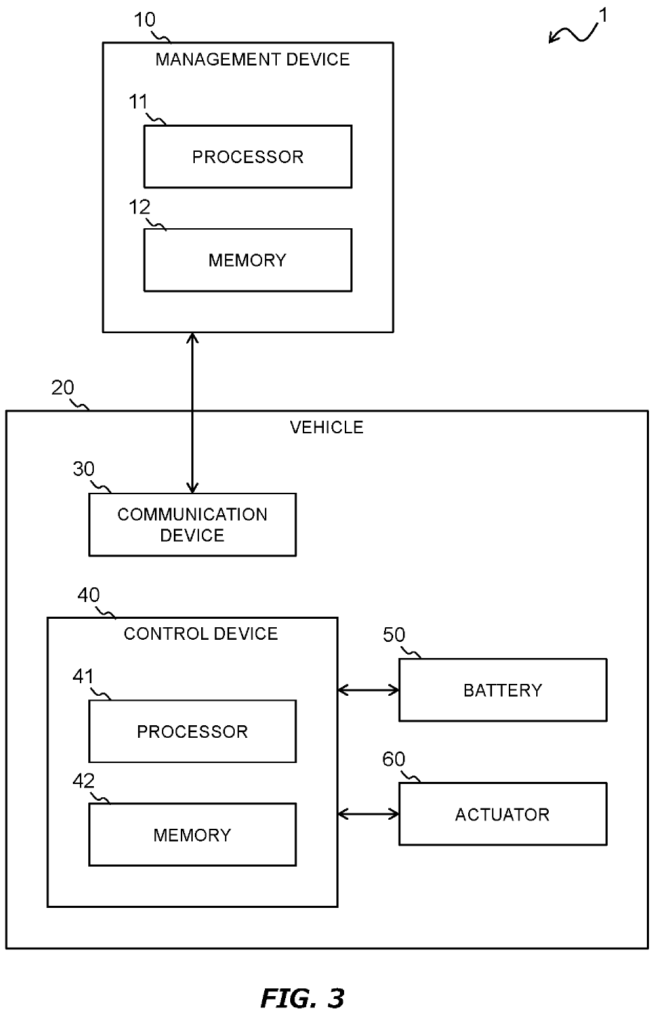

FIG. 3 is a block diagram showing an example of the configuration of the management system 1.

The management device 10 includes one or more processors 11 (hereinafter, simply referred to as a processor 11 or processing circuitry 11) and one or more memories 12 (hereinafter, simply referred to as a memory 12). The processor 11 executes various processes. The memory 12 stores various programs and various information necessary for processing by the processor 11. The processor 11 executes the program stored in the memory 12, thereby realizing the function of the management device 10.

The vehicle 20 includes a communication device 30, a control device 40, a battery 50, and an actuator 60. The vehicle 20 may be an autonomous driving vehicle or an AVP vehicle.

The communication device 30 communicates with the outside of the vehicle 20. For example, the communication device 30 communicates with the management device 10.

The actuator 60 includes a drive actuator, a braking actuator, and a steering actuator. The drive actuator includes at least one of an internal combustion engine and a motor.

The control device 40 is a computer that controls the vehicle 20. For example, the control device 40 controls the actuator 60 to control the traveling of the vehicle 20. When the vehicle 20 is an automatically driven vehicle, the control device 40 controls automatic driving of the vehicle 20. The control device 40 can acquire information on a remaining battery level (SOC) of the battery 50. Typically, the control device 40 is an aggregate of a plurality of electronic control units (ECUs). The control device 40 includes one or more processors 41 (hereinafter, simply referred to as a processor 41 or processing circuitry 41) and one or more memories 42 (hereinafter, simply referred to as a memory 42). The processor 41 executes various processes. The memory 42 stores various programs and various information necessary for processing by the processor 41. The processor 41 executes a program stored in the memory 42, and thus the control of the vehicle 20 by the control device 40 is realized.

### 4. Processing Performed by Management Device

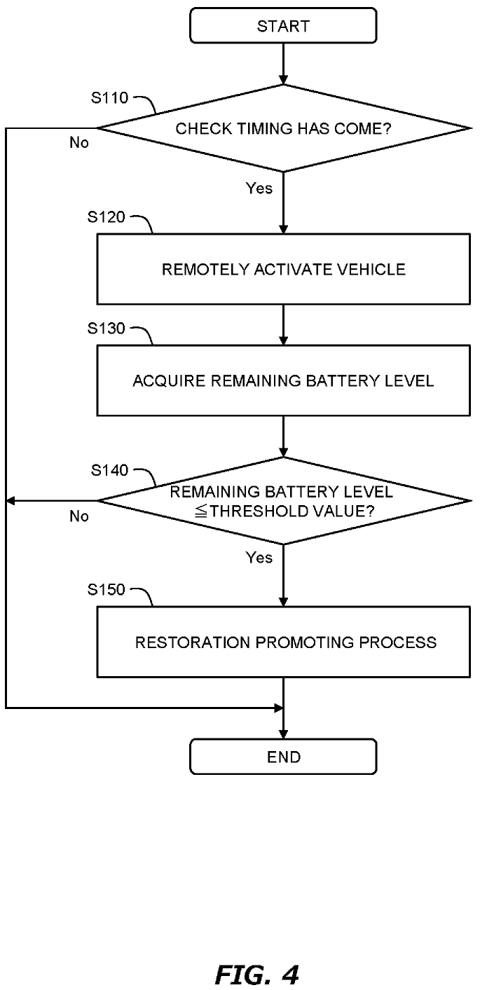

FIG. 4 is a flowchart showing a process executed by the management device 10, more specifically, a process executed by the processor 11. The flowchart shown in FIG. 4 is repeatedly executed at predetermined control intervals.

In step S110, the processor 11 determines whether or not the check timing has arrived. When the check timing has come (step S110; Yes), the processing proceeds to step S120. On the other hand, when the check timing has not arrived yet or when the check timing has not been set (step S110; No), the current process is terminated.

In step S120, the processor 11 remotely activates the vehicle 20. That is, the activation instruction is transmitted from the management device 10 to the communication device 30, and the vehicle 20 is activated in response to the reception of the activation instruction. When vehicle 20 is activated, the process proceeds to step S130.

In step S130, the processor 11 acquires the remaining battery level of the battery 50. The remaining battery level is first acquired by the control device 40. Then, the remaining battery level acquired by the control device 40 is transmitted from the communication device 30 to the management device 10. When the remaining battery level is acquired by the management device 10, the process proceeds to step S140.

In step S140, the processor 11 determines whether or not the remaining battery level is equal to or less than the reference value TH. If the remaining battery level is equal to or less than the reference value TH (step S140; Yes), the process proceeds to step S150. On the other hand, when the remaining battery level is larger than the reference value TH (step S140; Yes), the current process is terminated.

In step S150, the processor 11 performs a recovery promoting process. A specific example of the recovery promoting process is as described above. In step S150, the remaining battery level is recovered by performing the recovery facilitating process. When the restoration promoting process is performed, the series of processes is terminated.

Although not shown in FIG. 4, the communication device 30 that has entered the activated state from the standby state upon receiving the activation instruction in step S120 enters the standby state again when the input from the management device 10 is not received for a predetermined time. At this time, the vehicle 20 is also turned off again, and waits while suppressing power consumption until the next activation instruction is received from the management device 10.

In step S140 of FIG. 4, the determination regarding the power consumption amount from the vehicle 20 entering the garage to the present may be performed instead of the remaining battery level. In this case, the processor 11 acquires the remaining battery level when the vehicle 20 enters the parking lot. Then, the amount of decrease from the remaining battery level at the time of entering to the remaining battery level at this time, that is, the amount of power consumption from the time of entering is calculated. The processor 11 determines whether the power consumption is equal to or greater than the predetermined value in step S140. If the power consumption is equal to or greater than the predetermined value, the process proceeds to step S150, and the same recovery promoting process as that performed when the remaining battery level is equal to or less than the predetermined value TH is performed.

### 5. Modifications

### 5-1. First Modifications

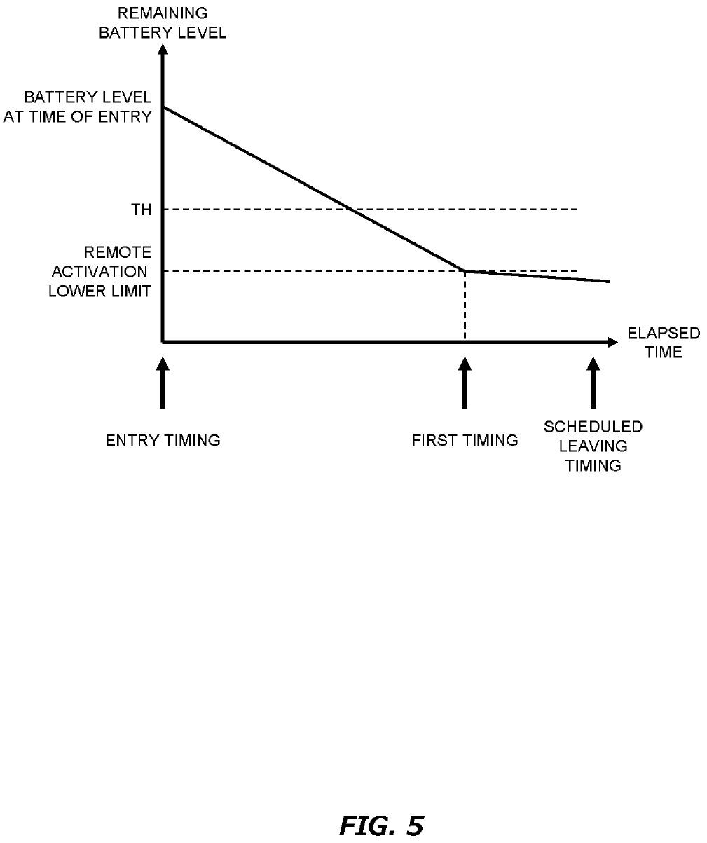

As a modification, the processor 11 may set the check timing when a predetermined condition is satisfied. FIG. 5 shows an example of a scene in which a predetermined condition is satisfied in the first modification.

In order to determine whether or not the predetermined condition is satisfied, the processor 11 estimates a “first timing”. The first timing is a timing at which the remaining battery level is estimated to decrease to the remote activation lower limit value. The processor 11 acquires the remaining battery level of the vehicle 20 at the time of entry of the vehicle 20 in order to estimate the first timing. Then, the processor 11 estimates the first timing based on the remaining battery level at the time of entry of the vehicle 20. Information for estimating the first timing from the remaining battery level at the time of vehicle entry is stored in the memory 12 in advance. For example, data on the decrease speed of the remaining battery level while the vehicle 20 is parked is collected in advance by the administrator or the like of the vehicle 20. Then, the average value of the decrease rates of the remaining battery level calculated from the collected data may be stored in the memory 12 as the predicted decrease rate of the remaining battery level. Then, the processor 11 may calculate the time until the remaining battery level reaches the remote activation lower limit value from the remaining battery level at the time of storage and the decreasing speed of the remaining battery level stored in the memory 12.

In the example of FIG. 5, the first timing is calculated based on the prediction that the remaining battery level decreases linearly, but the decrease speed of the remaining battery level may change according to the environment of the parking place of the vehicle 20 or the like. For example, when the parking place of the vehicle 20 is in an environment exposed to direct sunlight or a low-temperature environment, it is expected that the decreasing speed of the remaining battery level becomes high. Therefore, the first timing may be calculated to be a variable period according to these conditions. In this case, the memory 12 stores in advance information for calculating the decrease rate of the remaining battery level according to the environment of the parking place of the vehicle 20.

The processor 11 determines whether or not a predetermined condition is satisfied based on the first timing calculated in this way. The predetermined condition in the first modification is that the scheduled leaving timing of the vehicle 20 is later than the first timing. The scheduled leaving timing is a timing at which the vehicle 20 is scheduled to leave.

In the first modification, the satisfaction of the predetermined condition means that, if no measures are taken, the remaining battery level is expected to decrease to the remote activation lower limit value by the scheduled leaving timing of the vehicle 20. That is, if no countermeasure is taken, the vehicle 20 cannot be remotely activated before the scheduled leaving timing. In order to prevent such a situation, the processor 11 sets a check timing when a predetermined condition is satisfied, and checks whether the remaining battery level is equal to or less than the threshold TH while the vehicle 20 is parked. Then, when the remaining battery level is equal to or less than the threshold value TH, the recovery facilitating process is performed, and thus it is possible to prevent the vehicle 20 from being unable to be remotely activated.

The processor 11 can acquire information on the scheduled leaving timing of the vehicle 20 from the user terminal 201. For example, when the vehicle 20 is an AVP vehicle, it is assumed that the user 200 registers a scheduled time to board the vehicle 20 in the management device 10 through the user terminal 201. The registered time may be set as the scheduled leaving timing. Alternatively, when the vehicle 20 is a rental car, it is assumed that the user 200 reserves a time to get in the vehicle 20 through the user terminal 201. The reserved time may be set as the scheduled leaving timing.

### 5-2. Second Modifications

The second modification is also the same in that the check timing is set when a predetermined condition is satisfied. The same applies to the point that the processor 11 acquires the scheduled leaving timing and the point that the processor 11 estimates the first timing.

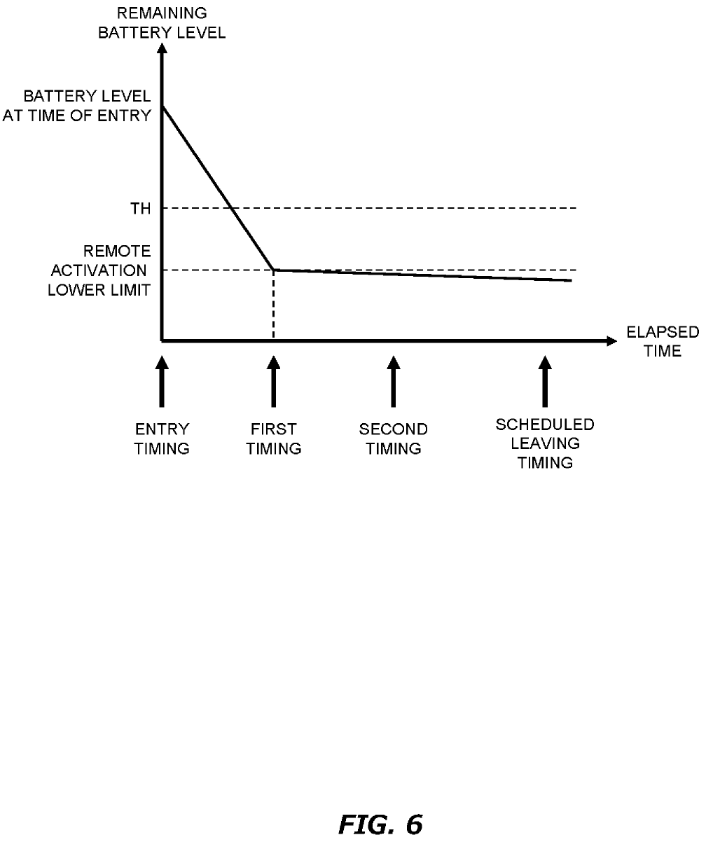

Further, in the second modification, a second timing later than the first timing is set. The second timing is configurable to the arbitrary timing. For example, a timing after a predetermined period has elapsed from the first timing may be set as the second timing. Then, the processor 11 determines that the predetermined condition is satisfied when the scheduled leaving timing is earlier than the second timing. That is, as shown in FIG. 6, when the scheduled leaving timing is later than the second timing, the check timing is not set.

In a case where the period in which the vehicle 20 is parked is a very long period, if the recovery facilitating process is performed every time the remaining battery level becomes equal to or lower than the threshold TH, the number of times the recovery facilitating process is performed before the scheduled leaving timing may be excessively increased. It is not preferable from the viewpoint of cost to keep the vehicle 20 in a state where the vehicle 20 can be remotely activated until the vehicle 20 performs the recovery facilitating process an excessively large number of times. Therefore, in the second modification, the check timing is set only when the predetermined condition as described above is satisfied. Thus, when the parking period of the vehicle 20 is longer than a certain period, the check timing is not set, and the recovery facilitating process can be prevented from being performed an excessive number of times.

When the scheduled leaving timing of the vehicle 20 is later than the second timing, it is predicted that the remaining battery level is lower than the remote activation lower limit value at the scheduled leaving timing. Therefore, when the scheduled leaving timing arrives, the vehicle 20 is manually activated. For example, it is assumed that the management device 10 notifies the user 200 to manually activate the vehicle 20 through the user terminal 201.

### 6. Processing Entity

In the above description, the processor 11 of the management device 10 performs a series of processes necessary for recovering the remaining battery level. However, at least a part of the series of processes may be performed by the processor 41 of the control device 40 on the vehicle 20 side. For example, some of the plurality of ECUs included in the control device 40 are in an operating state even while the vehicle 20 is parked. Then, when the check timing arrives, the ECU may activate the ECU necessary for acquiring the remaining battery level to acquire the remaining battery level. The processor 41 of the control device 40 may perform the determination on the remaining battery level, and when the remaining battery level is equal to or less than the threshold TH, the control device 40 may cause the vehicle 20 to travel to the charging device 101 and perform charging.

What is claimed is:

1. A management system for managing a vehicle having a remote activation function, the management system comprising processing circuitry, wherein
the processing circuitry is configured to:
activate the vehicle and acquire remaining battery level of the vehicle at check timing while the vehicle is parked; and
perform a restoration promoting process for restoring the remaining battery level in a case where the remaining battery level is equal to or lower than a threshold value, and
the threshold value is set to a value larger than a remote activation lower limit that is a lower limit of the remaining battery level necessary for remote activation of the vehicle.

2. The management system according to claim 1, wherein the check timing is after an elapse of a first period since the vehicle enters a parking place or since the vehicle is activated last time.

3. The management system according to claim 2, wherein the processing circuitry is further configured to change the first period in accordance with environment of a location where the vehicle is parked.

4. The management system according to claim 2, wherein
the check timing is after the elapse of the first period since the vehicle enters the parking place, and
the processing circuitry is further configured to set the first period based on the remaining battery level at a time of entry of the vehicle into the parking place.

5. The management system according to claim 1, wherein the processing circuitry is further configured to:
acquire information about scheduled leaving timing at which the vehicle is scheduled to leave a parking place;
estimate first timing at which the remaining battery level decreases to the remote activation lower limit based on the remaining battery level at a time of entry of the vehicle into the parking place; and
set the check timing in a case where a predetermined condition including that the scheduled leaving timing is later than the first timing is satisfied.
